(19) United States
(12) Patent Application Publication
(10) Pub. No.: US 2025/0260189 A1
(43) Pub. Date: Aug. 14, 2025

(54) CONNECTOR ASSEMBLY

(71) Applicant: BIZLINK INTERNATIONAL CORP., New Taipei City (TW)

(72) Inventors: Xiangwu WANG, New Taipei City (TW); Chubei ZHANG, New Taipei City (TW)

(21) Appl. No.: 18/438,510

(22) Filed: Feb. 11, 2024

(51) Int. Cl. H01R 13/422; H01R 13/533

(52) U.S. Cl. CPC H01R 13/422; H01R 13/533

(57) ABSTRACT

A connector assembly includes a housing, a pad, and a conductive terminal. The housing has a through hole and a retaining wall in the through hole. The pad is fixed to the retaining wall. The conductive terminal inserts into the through hole. The conductive terminal is spaced apart from the retaining wall by the pad.

### BACKGROUND

### Technical Field

The present disclosure relates to a connector assembly.

### Description of Related Art

In the related art, a connector structure is known in which a pair of connectors (i.e., a male connector and a female connector) are fitted with each other to electrically connect terminals of the two connectors. For example, the male connector is inserted into a cover portion of the female connector mounted on a circuit board to achieve fitting of two connectors and electrical connection between terminals. When the above connector structure is actually used, the temperature of the terminals increases due to the heat generated on the terminals when power is supplied. In particular, due to contact resistance, the degree of temperature rise is often large at the contact position of the terminals.

However, since the terminals and the contact position between the terminals are surrounded by the housings of the two connectors that are fitted to each other, it is usually difficult to release the generated heat to the outside. In particular, when a large current passes through the connector structure in a short time, deterioration of components may be caused by large thermal stresses generated in the components (e.g., the housings of the connectors, the solder at the contact point between the terminals and the circuit board, or the circuit board) around the terminals or thermal fatigue caused by repeated increases and decreases in thermal stresses.

Accordingly, how to prevent component deterioration due to the heat generated during the above operation to solve the aforementioned problems becomes an important issue to be solved by those in the industry.

### SUMMARY

An aspect of the disclosure is to provide a connector assembly that can efficiently solve the aforementioned problems.

According to an embodiment of the disclosure, a connector assembly includes a housing, a pad, and a conductive terminal. The housing has a through hole and a retaining wall in the through hole. The pad is fixed to the retaining wall. The conductive terminal inserts into the through hole. The conductive terminal is spaced apart from the retaining wall by the pad.

In an embodiment of the disclosure, the through hole has a first opening and a second opening opposite to each other. The conductive terminal inserts into the through hole from the second opening. The retaining wall has a first surface and a second surface respectively facing the first opening and the second opening. The pad is in contact with the second surface.

In an embodiment of the disclosure, an inner surface of the through hole has a first side and a second side opposite to each other. The retaining wall is connected to the first side and extends toward the second side. The conductive terminal passes through the retaining wall via a gap formed between the retaining wall and the second side.

In an embodiment of the disclosure, a height of the retaining wall relative to the first side is greater than a height of the pad relative to the first side.

In an embodiment of the disclosure, the retaining wall includes a protrusion. The pad includes an engaging hole. The protrusion is engaged with the engaging hole.

In an embodiment of the disclosure, a material of the retaining wall includes plastic. A material of the pad includes metal.

In an embodiment of the disclosure, the conductive terminal is in contact with the pad.

In an embodiment of the disclosure, the conductive terminal includes a terminal portion and at least one extending portion. The terminal portion inserts into the through hole. The at least one extending portion is connected to the terminal portion and in contact with the pad.

In an embodiment of the disclosure, a number of the at least one extending portion is two. The extending portions are respectively connected to opposite two edges of the terminal portion.

In an embodiment of the disclosure, the terminal portion has two end surfaces respectively at the two edges. The extending portions are respectively extended away from the end surfaces.

In an embodiment of the disclosure, the terminal portion is bended such that the extending portions are extended to a side of the terminal portion adjacent to the retaining wall.

In an embodiment of the disclosure, the conductive terminal includes a terminal portion and an elastic portion. The terminal portion inserts into the through hole. The elastic portion is connected to the terminal portion and in contact with an inner surface of the through hole.

In an embodiment of the disclosure, the elastic portion has a connecting end connected to an end of the terminal portion in the through hole. The inner surface of the through hole has a first side and a second side opposite to each other. The terminal portion is between the first side and the elastic portion. The elastic portion is between the terminal portion and the second side.

In an embodiment of the disclosure, the elastic portion further has a distal end abutting against the terminal portion.

In an embodiment of the disclosure, the terminal portion further has a protrusion protruding toward the elastic portion and abutting against the distal end.

According to an embodiment of the disclosure, the connector assembly includes a housing, a pad, and a conductive terminal. The housing has a through hole and a retaining wall in the through hole. The retaining wall has a first surface and a second surface facing away from each other. The pad is fixed to the second surface of the retaining wall. The conductive terminal inserts into the through hole and passes through the retaining wall from a side of the second surface to a side of the first surface. The conductive terminal abuts against a side of the pad away from the retaining wall.

Accordingly, in the connector assembly of the present disclosure, the conductive terminal that inserts into the through hole of the housing is spaced apart from the retaining wall in the through hole by the pad. In other words, the conductive terminal abuts against the retaining wall through the pad and is protected from contact with the retaining wall. In this way, when the conductive terminal is installed in the housing by welding, for example, or when the connector assembly is hot-plugged, the heat generated on the conductive terminal will not damage the housing, so the conductive terminal can be prevented from being deformed or loosened.

It is to be understood that both the foregoing general description and the following detailed description are by examples, and are intended to provide further explanation of the disclosure as claimed.

### BRIEF DESCRIPTION OF THE DRAWINGS

The disclosure can be more fully understood by reading the following detailed description of the embodiment, with reference made to the accompanying drawings as follows:

FIG. 1 is a perspective view of a connector assembly according to an embodiment of the present disclosure;

FIG. 2 is another perspective view of the connector assembly in FIG. 1;

FIG. 3 is an exploded view of the connector assembly in FIG. 2;

FIG. 4 is a perspective cross-sectional view of the connector assembly in FIG. 2;

FIG. 5 is a perspective view of a conductive terminal in FIG. 3; and

FIG. 6 is a partial cross-sectional view of the connector assembly in FIG. 4.

### DETAILED DESCRIPTION

Reference will now be made in detail to the present embodiments of the disclosure, examples of which are illustrated in the accompanying drawings. Wherever possible, the same reference numbers are used in the drawings and the description to refer to the same or like parts. However, specific structural and functional details disclosed herein are merely representative for purposes of describing example embodiments, and thus may be embodied in many alternate forms and should not be construed as limited to only example embodiments set forth herein. Therefore, it should be understood that there is no intent to limit example embodiments to the particular forms disclosed, but on the contrary, example embodiments are to cover all modifications, equivalents, and alternatives falling within the scope of the disclosure.

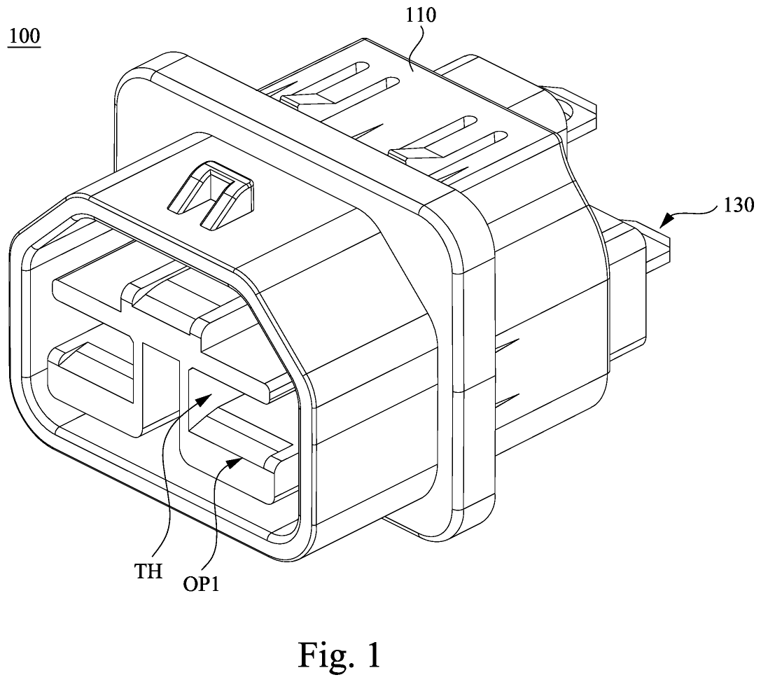

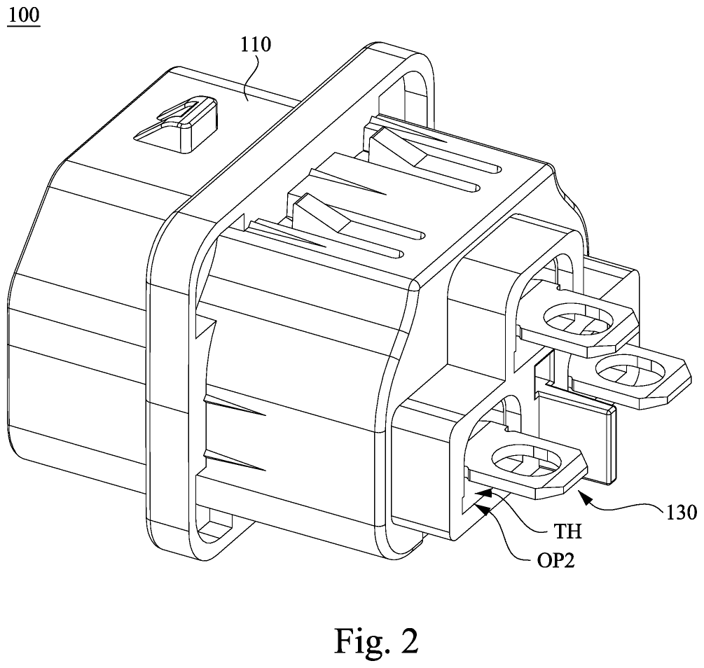

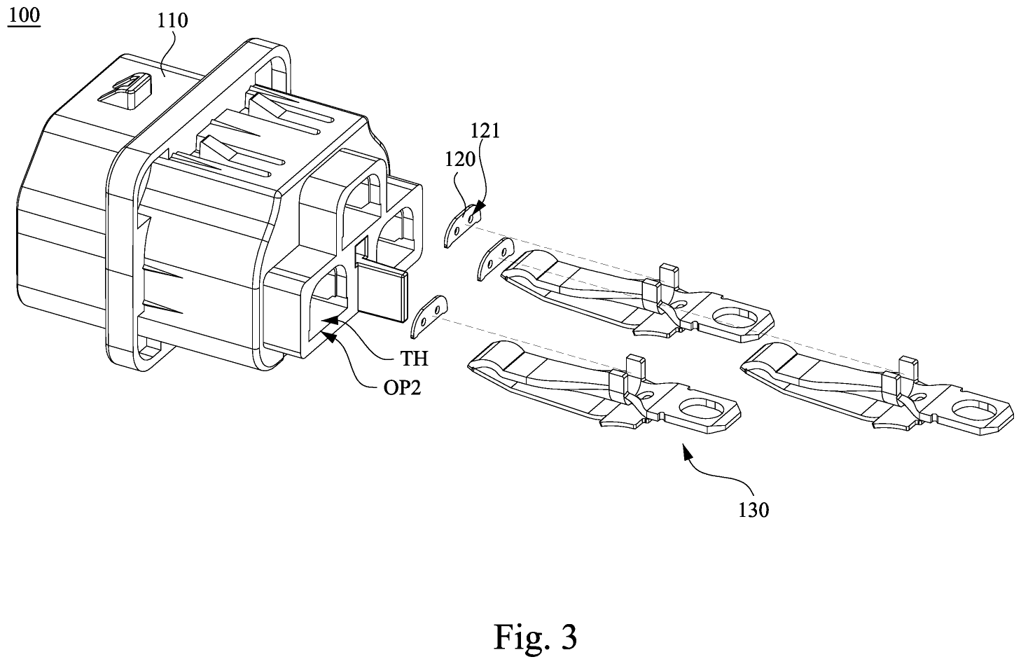

Reference is made to FIGS. 1, 2, and 3. FIG. 1 is a perspective view of a connector assembly 100 according to an embodiment of the present disclosure. FIG. 2 is another perspective view of the connector assembly 100 in FIG. 1. FIG. 3 is an exploded view of the connector assembly 100 in FIG. 2. As shown in FIGS. 1 to 3, in the present embodiment, the connector assembly 100 includes a housing 110, a plurality of pads 120, and a plurality of conductive terminal 130. The housing 110 has a plurality of through holes TH. Each of the through holes TH has a first opening OP1 and a second opening OP2 opposite to the first opening OP1. The pads 120 are respectively accommodated in the through holes TH. The conductive terminals 130 respectively insert into the through holes TH from the second openings OP2. In other words, the conductive terminals are placed in the through holes TH and partially exposed from the second openings OP2 to the outside of the housing 110.

In the present embodiment, the number of the through holes TH, the number of the pads 120, and the number of the conductive terminals 130 are all three, but the disclosure is not limited in this regard and can be flexibly changed according to actual needs.

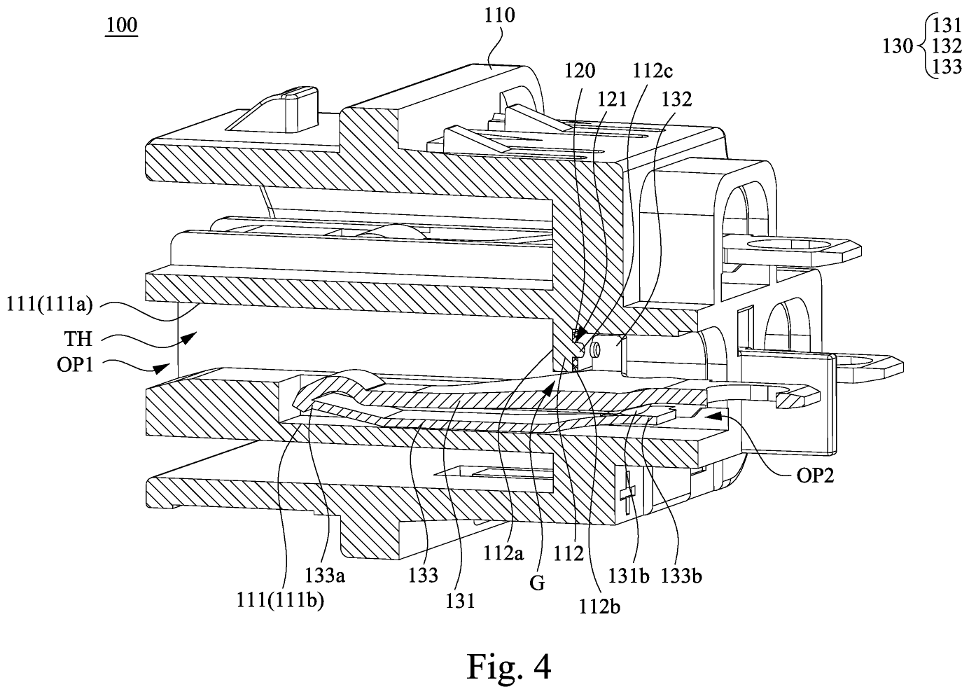

Reference is made to FIG. 4. FIG. 4 is a perspective cross-sectional view of the connector assembly 100 in FIG. 2. The present embodiment will be described below with one of the conductive terminals 130 and a corresponding one of the pads 120 in a corresponding one of the through holes TH as a representative. As shown in FIG. 4, in the present embodiment, the housing 110 has a plurality of retaining wall 112. The retaining wall 112 is in the through hole TH. Specifically, the through hole TH has an inner surface 111. The inner surface 111 has a first side 111a and a second side 111b opposite to each other. For example, the first side 111a is the upper side of the inner surface 111 in FIG. 4, and the second side 111b is the lower side of the inner surface 111 in FIG. 4. The retaining wall 112 is connected to the first side 111a and extends toward the second side 111b. The conductive terminal 130 that inserts into the through hole TH passes through the retaining wall via a gap G formed between the retaining wall 112 and the second side 111b of the inner surface 111. That is, an end of the conductive terminal 130 in the through hole TH is adjacent to the first opening OP1 and away from a corresponding one of the second openings OP2, and an end of the conductive terminal 130 outside the housing 110 is adjacent to the corresponding one of the second openings OP2 and away from the first opening OP1.

As shown in FIG. 4, in the present embodiment, the conductive terminal 130 is spaced apart from the retaining wall 112 by the pad 120. In other words, the conductive terminal 130 abuts against the retaining wall 112 through the pad 120 and is protected from contact with the retaining wall 112. It should be noted that in some embodiments, a material of the housing 110 (including the retaining wall 112) may include, for example, plastic, a material of the pad 120 includes metal, and the housing 110 including this material is prone to melting due to high temperatures. In this way, when the conductive terminal 130 is installed in the housing 110 by welding, for example, or when the connector assembly 100 is hot-plugged, the heat generated on the conductive terminal 130 will not damage the housing 110, so the conductive terminal 130 can be prevented from being deformed or loosened.

In detail, as shown in FIG. 4, the retaining wall 112 has a first surface 112a and a second surface 112b. The first surface 112a and the second surface 112b respectively face the first opening OP1 and the second opening OP2 of the through hole TH. The conductive terminal 130 inserting into the through hole TH passes through the retaining wall 112 from a side of the second surface 112b to a side of the first surface 112a. The pad 120 abuts against and is in contact with the second surface 112b. The conductive terminal 130 abuts against and is in contact with a side of the pad 120 away from the retaining wall 112. In other words, the pad 120 is sandwiched between the second surface 112b and the conductive terminal 130.

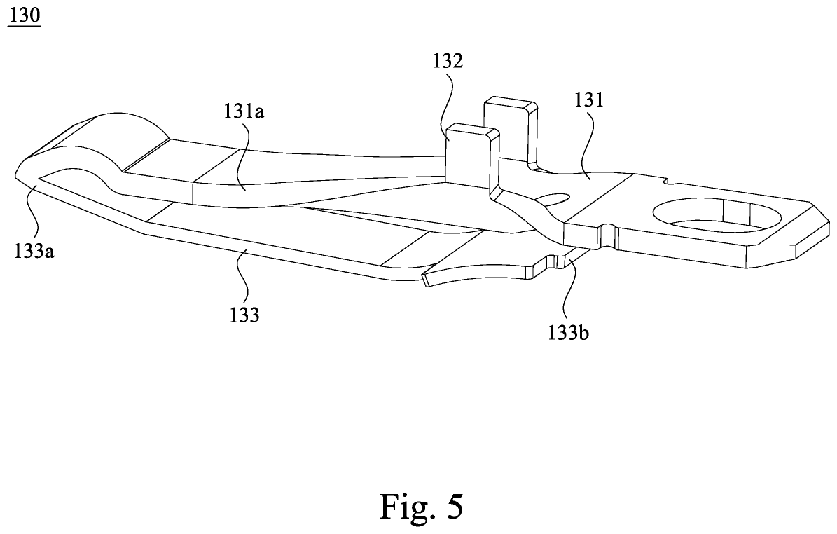

Reference is made to FIG. 5. FIG. 5 is a perspective view of the conductive terminal 130 in FIG. 3. As shown in FIGS. 4 and 5, in the present embodiment, the conductive terminal 130 includes a terminal portion 131 and a plurality of extending portions 132. The terminal portion 131 inserts into the through hole TH from the second opening OP2. The terminal portion 131 passes through the retaining wall 112 via the gap G formed between the retaining wall 112 and the second side 111b of the inner surface 111. The extending portions 132 are connected to the terminal portion 131 and in contact with the pad 120. In other words, the conductive terminal 130 abuts against the retaining wall 112 through the pad 120 by the extending portions 132. The pad 120 is configured to block and prevent the heat generated by the conductive terminal 130 from transmitting to the retaining wall 112 of the housing 110 via the extending portions 132.

In some embodiments, a number of the extending portions 132 is two, but the disclosure is not limited in this regard and can be flexibly changed according to actual needs.

As shown in FIG. 5, in the present embodiment, the extending portions 132 are respectively connected to opposite two edges of the terminal portion 131. Specifically, the terminal portion 131 has two end surfaces 131a respectively at the two edges. The extending portions 132 are respectively extended away from the end surfaces 131a. As shown in FIG. 5 with reference to FIG. 4, the terminal portion 131 is bended such that the extending portions 132 are extended to a side of the terminal portion 131 adjacent to the retaining wall 112. In other words, the extending portions 132 extend toward the first side 111a and away from the second side 111b of the inner surface 111.

As shown in FIG. 5, in the present embodiment, the conductive terminal 130 further includes an elastic portion 133. The elastic portion 133 is connected to the terminal portion 131. With reference to FIG. 4, the elastic portion 133 is in contact with second side 111b of the inner surface 111 of the through hole TH. Specifically, the elastic portion 133 has a connecting end 133a. The connecting end 133a is connected to the end of the terminal portion 131 in the through hole TH. The terminal portion 131 is between the first side 111a of the inner surface 111 and the elastic portion 133. The elastic portion 133 is between the terminal portion 131 and the second side 111b of the inner surface 111.

In addition, the elastic portion 133 further has a distal end 133b. The connecting end 133a and the distal end 133b respectively are opposite ends of the elastic portion 133. The distal end 133b abuts against the terminal portion 131. In detail, the distal end 133b is adjacent to an end of the terminal portion 131 outside the housing 110 and is away from an end of the terminal portion 131 connected to the connecting end 133a.

As shown in FIG. 4, in the present embodiment, the terminal portion 131 further has a protrusion 131b. The protrusion 131b protrudes toward the elastic portion 133 and abuts against the distal end 133b. In some embodiments, the protrusion 131b may be formed by performing a stamping process on the terminal portion 131 towards the elastic portion 133, but the present disclosure is not limited in this regard.

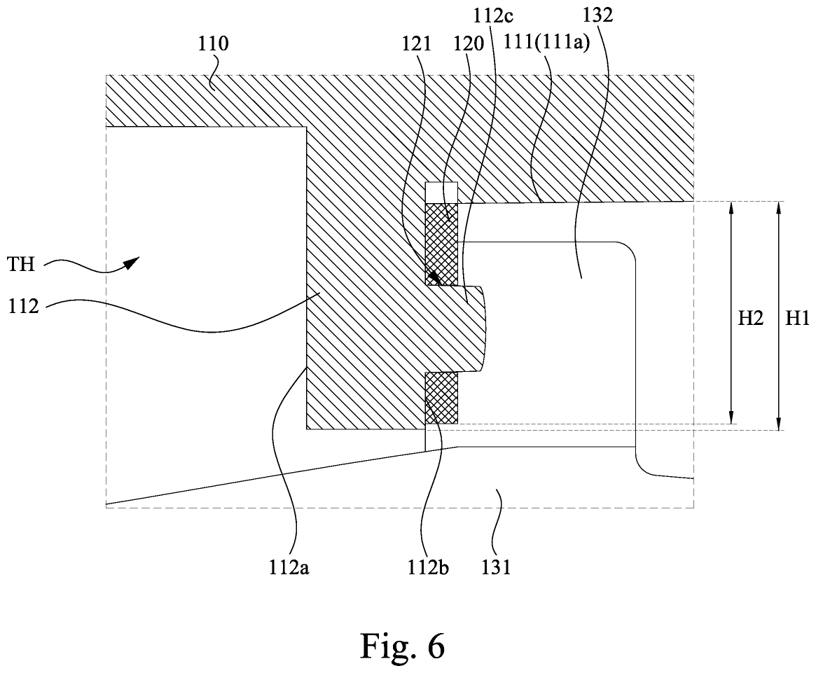

Reference is made to FIG. 6. FIG. 6 is a partial cross-sectional view of the connector assembly 100 in FIG. 4. As shown in FIGS. 4 and 6, in the present embodiment, the retaining wall 112 includes two protrusions 112c. The pad 120 includes two engaging holes 121. The protrusions 112c are respectively engaged with the engaging hole 121. In this way, the pad 120 can be fixed to the second surface 112b of the retaining wall 112.

In some embodiments, a material of the pad 120 includes metal, but the present disclosure is not limited in this regard. It should be noted that the gap between the retaining wall 112 and the pad 120 and the gap between the pad 120 and the extending portions 132 increase the thermal resistance of heat transfer from the extending portions 132 to the retaining wall 112 via the pad 120. Therefore, even if the material of the pad 120 includes metal, the pad 120 can still achieve the purpose of preventing the heat generated on the conductive terminal 130 from damaging the retaining wall 112.

As shown in FIG. 6, in the present embodiment, a height H1 of the retaining wall 112 relative to the first side 111a of the inner surface 111 is greater than a height H2 of the pad 120 relative to the first side 111a, but the disclosure is not limited in this regard. In some other embodiment, the height H2 of the pad 120 relative to the first side 111a is greater than the height H1 of the retaining wall 112 relative to the first side 111a. In this way, the pad 120 may further prevent the terminal portion 131 of the conductive terminal 130 from being in contact with the retaining wall 112.

According to the foregoing recitations of the embodiments of the disclosure, it can be seen that in the connector assembly of the present disclosure, the conductive terminal that inserts into the through hole of the housing is spaced apart from the retaining wall in the through hole by the pad. In other words, the conductive terminal abuts against the retaining wall through the pad and is protected from contact with the retaining wall. In this way, when the conductive terminal is installed in the housing by welding, for example, or when the connector assembly is hot-plugged, the heat generated on the conductive terminal will not damage the housing, so the conductive terminal can be prevented from being deformed or loosened.

Although the present disclosure has been described in considerable detail with reference to certain embodiments thereof, other embodiments are possible. Therefore, the spirit and scope of the appended claims should not be limited to the description of the embodiments contained herein.

It will be apparent to those skilled in the art that various modifications and variations can be made to the structure of the present disclosure without departing from the scope or spirit of the disclosure. In view of the foregoing, it is intended that the present disclosure cover modifications and variations of this disclosure provided they fall within the scope of the following claims.

What is claimed is:

1. A connector assembly, comprising:
a housing having a through hole and a retaining wall in the through hole;
a pad fixed to the retaining wall; and
a conductive terminal inserting into the through hole, wherein the conductive terminal is spaced apart from the retaining wall by the pad.

2. The connector assembly of claim 1, wherein the through hole has a first opening and a second opening opposite to each other, the conductive terminal inserts into the through hole from the second opening, the retaining wall has a first surface and a second surface respectively facing the first opening and the second opening, and the pad is in contact with the second surface.

3. The connector assembly of claim 2, wherein an inner surface of the through hole has a first side and a second side opposite to each other, the retaining wall is connected to the first side and extends toward the second side, and the conductive terminal passes through the retaining wall via a gap formed between the retaining wall and the second side.

4. The connector assembly of claim 3, wherein a height of the retaining wall relative to the first side is greater than a height of the pad relative to the first side.

5. The connector assembly of claim 1, wherein the retaining wall comprises a protrusion, the pad comprises an engaging hole, and the protrusion is engaged with the engaging hole.

6. The connector assembly of claim 5, wherein a material of the retaining wall comprises plastic, and a material of the pad comprises metal.

7. The connector assembly of claim 1, wherein the conductive terminal is in contact with the pad.

8. The connector assembly of claim 7, wherein the conductive terminal comprises:
a terminal portion inserting into the through hole; and
at least one extending portion connected to the terminal portion and in contact with the pad.

9. The connector assembly of claim 8, wherein a number of the at least one extending portion is two, and the extending portions are respectively connected to opposite two edges of the terminal portion.

10. The connector assembly of claim 9, wherein the terminal portion has two end surfaces respectively at the two edges, and the extending portions are respectively extended away from the end surfaces.

11. The connector assembly of claim 9, wherein the terminal portion is bended such that the extending portions are extended to a side of the terminal portion adjacent to the retaining wall.

12. The connector assembly of claim 1, wherein the conductive terminal comprises:
a terminal portion inserting into the through hole; and
an elastic portion connected to the terminal portion and in contact with an inner surface of the through hole.

13. The connector assembly of claim 12, wherein the elastic portion has a connecting end connected to an end of the terminal portion in the through hole, the inner surface of the through hole has a first side and a second side opposite to each other, the terminal portion is between the first side and the elastic portion, and the elastic portion is between the terminal portion and the second side.

14. The connector assembly of claim 13, wherein the elastic portion further has a distal end abutting against the terminal portion.

15. The connector assembly of claim 14, wherein the terminal portion further has a protrusion protruding toward the elastic portion and abutting against the distal end.

16. A connector assembly, comprising:
a housing having a through hole and a retaining wall in the through hole, wherein the retaining wall has a first surface and a second surface facing away from each other;
a pad fixed to the second surface of the retaining wall; and
a conductive terminal inserting into the through hole and passing through the retaining wall from a side of the second surface to a side of the first surface, wherein the conductive terminal abuts against a side of the pad away from the retaining wall.
